(19) United States
(12) Patent Application Publication
(10) Pub. No.: US 2013/0195138 A1
(43) Pub. Date: Aug. 1, 2013

(54) HEAT EXCHANGER FOR THE RAPID COOLING OF FLUE GAS OF IRONWORK PLANTS, APPARATUS FOR THE TREATMENT OF FLUE GAS OF IRONWORK PLANTS COMPRISING SUCH A HEAT EXCHANGER AND RELATIVE TREATMENT METHOD

(71) Applicant: Nicola Ambrogio Maria Monti, Milano (IT)

(72) Inventor: Nicola Ambrogio Maria Monti, Milano (IT)

(73) Assignee: TENOVA S.P.A., Milano (IT)

(21) Appl. No.: 13/823,195

(22) PCT Filed: Sep. 21, 2011
(86) PCT No.: PCT/IB2011/054145

§ 371 Date: Apr. 16, 2013

(30) Foreign Application Priority Data
Sep. 23, 2010 (IT) MI 2010 A 001734

(51) Int. Cl. F28F 13/08; F27B 3/10; F27B 3/08; F28D 9/00; F23J 15/00

(52) U.S. Cl. CPC F28F 13/08; F28D 9/00; F23J 15/00; F27B 3/085; F27B 3/10
USPC 373/80; 165/175; 165/147; 110/203; 110/216; 110/345

(57) ABSTRACT

A heat exchanger rapid cooling flue gas of ironwork plants, including: a support structure of at least one module including an inlet manifold and an outlet manifold of the flue gas, mutually opposed and aligned; plural panels that extend between the inlet manifold and the outlet manifold mutually superimposed at a defined distance, pairs of adjacent panels defining flow channels of the flue gas closed laterally by shoulders and including at opposite ends respectively an inlet aperture communicating with the inlet manifold and an outlet aperture communicating with the outlet manifold; circulation ducts of a cooling fluid associated with the panels; and a first selective closing mechanism of the inlet apertures and a second selective closing mechanism of the outlet apertures of one or more of the channels; each of the channels laterally closed by a respective pair of shoulders of which at least one is of removable type.

The present invention refers to a heat exchanger for the rapid cooling of flue gas of ironwork plants.

The present invention also refers to an apparatus for the treatment of flue gas of ironwork plants comprising such a heat exchanger and relative treatment method.

With specific reference to ironwork plants and, in particular, to steelworks plants, it is known that they emit great quantities of flue gas at temperatures that vary between 1500-1800° C. (at the outlet of electrical furnaces) and 800-900° C. (at the outlet of afterburners or preheating systems of the feed material), wherein both dusts containing oxides, metals and metal oxides (Fe, CaO, Al₂O₃, SiO₂, MnO, Zn, Cu, Cr, Ni, etc.), and polluting substances, such as for example the products of combustion of polymeric organic substances present in the feed material are present.

The regulations applicable in various countries impose strict restrictions on the temperature and composition of emissions into the atmosphere, to satisfy which the flue gas must be subjected to cooling and reduction treatments that have a great impact on the running costs of the plants.

In order to limit the economic impact of such treatments, for a long time technologies have been developed aimed at recovering both the heat of the flue gas, and the dusts therein contained.

With regard to the dusts, once they have been separated from the flue gas in suitable dust remover apparatuses, they are subjected to recovery treatments of the reusable substances therein present, including, in particular, metals such as Fe, Zn, Pb, Cr and others. Such treatments are known and well-established and are based on pyro-metallurgy or pyro-hydrometallurgy processes.

With regard to the heat of the flue gas, it is, for example, used to preheat the feed material of the electrical furnaces or air used as comburent in post-combustion processes of the flue gas itself or as an energy source for steam production.

Technologies of this type are for example described in WO2005/083130 and in U.S. Pat. No. 4,655,436.

An aspect that concerns in particular ironworks flue gas and, even more specifically, steelworks flue gas is the presence in it of dioxin and/or furans, by such terms intending to indicate the entire “toxicological” class of dioxins, dioxin-like substances and furans and/or their precursors.

The presence of such substances is due, mainly, to the use of raw materials containing polymeric organic substances, in particular chlorinated substances, as feed material of furnaces for the steel production. Such raw materials consist for example of metal scrap wherein, for example, paints, oils, rubbers, plastic materials and the like are present.

It is known that dioxins are eliminated by combustion by keeping the flue gas at temperatures above 800-850° C. for a sufficiently long time. However, it is also known that dioxins can reform in the “cold” sections of the flue gas treatment plants. Indeed, if in the flue gas precursors (chlorobenzene and chlorophenols) of dioxin are present, formed by the combustions of polymeric organic substances present in the scrap used as feed material, these precursors, in the temperature range between about 800° C. and about 200° C., react forming dioxins in increasingly large quantities the longer they stay in such a temperature range.

The presence in the flue gas of ironwork plants, and in particular in the flue gas of steelwork plants, both of dusts, and of chemical pollutants, including dioxins, furans and/or their precursors, as well as other substances such as acids and salts, makes it problematic to recover the heat contained in the flue gas itself in order to reuse it. On one hand, indeed, the dusts, among which metal oxides, have an abrasive and erosive effect on the surfaces with which they come into contact, to limit which the flow speed of the flue gas is reduced. As the flow speed of the flue gas decreases, however, the separation from it and the depositing of the dusts themselves increase, which, due to their limited heat exchange coefficient, reduce the heat exchange capacity. On the other hand, it is necessary to ensure that the content of polluting, toxic or harmful substances, in particular dioxins and furans present in the flue gas released into the atmosphere, is within the limits set by regulations.

The technologies developed up to now have focussed on the reduction of polluting, toxic or harmful substances. Such technologies are based on chemical, physical and thermal treatments.

A known chemical treatment consists of injecting a suitable chemical agent, for example having the property of inhibiting the formation of such substances or of capturing their precursors, directly in a section of the path followed by the flue gas, as described for example in JP2008-049206 or in JP2007-268372.

The addition of chemical agents into a polluted and dirty environment like that inside the ducts crossed by the flue gas of ironwork plants, the composition of which is also not constant and known a priori, can originate unpredictable chemical reactions from which substances different from those foreseen may form, which can be harmful for the environment and/or for the plant itself.

Moreover, the injection of such chemical agents directly into the ducts crossed by the flue gas makes it difficult to ensure their homogeneous distribution. Finally, the dusts and the particulate present in the flue gas tend to intercept and incorporate the injected chemical agents, reducing their effectiveness.

Another known chemical treatment consists of the so-called scrubbing of the flue gas through injection of water, nebulised or in rain form, directly in the ducts crossed by the flue gas or in suitable chambers or towers provided along the path followed by the flue gas itself.

An example of a system for scrubbing and simultaneously cooling the flue gas through nebulisation of water directly in the discharge duct of the flue gas is described in GB 1,235,803.

The water introduced into the flow of flue gas dissolves the soluble substances present in it. Such a treatment, however, has limited effectiveness against dioxins and furans due to the low solubility of such compounds in water. The effectiveness increases if activated coke is introduced into the washing fluid.

Such systems also involve the problem of disposing of the waste. Indeed, the harmful substances are actually transferred into the washing fluid that, therefore, must be suitably treated or disposed of.

The effectiveness of the chemical treatments described above (by direct injection of chemical agents or by scrubbing), finally, is limited by the temperature of the flue gas. The greater such a temperature, the greater the possibility that the chemical agent or scrubbing fluid evaporate without performing its action or releasing the particulate captured by it.

Physical treatments are based on the use of filters, in particular active carbon filters. The effectiveness of such filters is, however, linked to the temperature of the flue gas that cross them—the higher the temperature, the less effective the filtration is. Therefore, they require a reduction of the temperature of the entering flue gas as well as at least one pre-filtering or decanting treatment in order to avoid the clogging of the filter itself and, then, its regeneration or replacement.

In order to reduce the temperature of the flue gas to be filtered, as well as that to be subjected to chemical treatment, it is known both mixing it with ambient air, and treating it in a heat exchanger of the radiant type known in the field as a “hair pin cooler”.

In the case in which the flue gas is mixed with ambient air, there is a disadvantageous increase of the volumes to be treated.

The heat exchangers of the radiant type, on the other hand, are used to reduce the temperature of the flue gas to be treated both through injection of active coke dust into it, and through filtration thereof through an active carbon bed.

They consist of a tube bundle having diameter comprised between 300 mm and 600 mm, length comprised between 8 m and 20 m, arranged outside of the sheds of an ironwork plant where, in addition to the transmission by radiation of the heat from the wall of the duct to the surrounding environment, the ambient air that licks the tubes acts as a cooling fluid. Such a type of cooling does not have constant and repeatable characteristics; one only has to think of the climatic variations that impact on the temperature of the ambient air. In such heat exchangers, moreover, due to the dimensions of the tubes, the flue gas undergoes a strong slowing down that, if on the one hand reduces the abrasive effect that they have on the tubes themselves, on the other hand favours the depositing of dusts, in particular of metal oxides, which then hinder the heat exchange.

Finally, for the specific purpose of hindering the synthesis of dioxins in the “cold” areas of the flue gas treatment plants, it is known to subject them to the so-called quenching.

Currently, quenching is carried out with “wet” methods or with “dry” methods.

“Wet” quenching methods are totally similar to a washing treatment (scrubbing) and consist of nebulising or injecting a cooling fluid, in general water, into the flow of flue gas. Such methods, therefore, have the same drawbacks highlighted above in relation to scrubbing methods, among which, in particular, the production of waste to be treated or disposed of.

“Dry” quenching methods are based on blowing air into the flow of flue gas, as described for example in JP2000210522, or on the use of tube bundle heat exchangers, as described for example in CN101274212 or in JP59112197.

In tube bundle heat exchangers, however, deposits and encrustations of dusts easily and frequently form that, on the one hand, reduce the heat exchange efficiency and, therefore, the drasticness of the temperature reduction required for effective quenching, and that, on the other hand, clog the tubes hindering the flow of flue gas.

In order to avoid such drawbacks a high number of tubes is generally provided, so as to compensate the reduction in flow speed and in heat exchange that can generate during the operation of exchangers of this kind.

In any case, such heat exchangers require cleaning interventions that can only be carried out during a plant stop time and that are made complex and laborious by the presence of numerous tubes.

The purpose of the present invention is to avoid the drawbacks of the prior art described above.

In particular, a purpose of the present invention is to provide a heat exchanger for the rapid cooling of flue gas of ironwork plants that allows the temperature of such flue gas to be quickly and drastically reduced in order to control the synthesis of dioxins and/or furans, so as to respect the limits of their concentrations set by the standards relative to atmospheric emissions.

A further purpose of the present invention is to provide a heat exchanger for the rapid cooling of flue gas of ironwork plants which is structurally and constructively simple and that allows maintenance or cleaning interventions to be carried out easily, even without requiring the plant to be shut off.

Yet another purpose of the present finding is to provide a heat exchanger for the rapid cooling of flue gas of ironwork plants that allows the heat subtracted to the flue gas crossing it to be recovered.

Yet another purpose of the present invention is to provide an apparatus for the treatment of flue gas of ironwork plants and relative treatment method that allow the temperature of the flue gas to be quickly and drastically reduced in order to control the synthesis of dioxins and/or furans, so as to respect the limits of their concentrations set by the standards, and that allow the heat extracted from the flue gas itself to be efficiently recovered.

Another purpose of the present invention is to realize a heat exchanger for the rapid cooling of flue gas of ironwork plants and an apparatus for the treatment of flue gas of ironwork plants that are particularly simple and functional, with low costs.

These purposes according to the present invention are accomplished by realizing a heat exchanger for the rapid cooling of flue gas of ironwork plants, characterized in that it comprises a support structure of at least one module which in turn comprises an inlet manifold of the flue gas and an outlet manifold of the flue gas which are mutually opposed and aligned, a plurality of panels that extend between said inlet manifold and said outlet manifold and which are mutually superimposed at a defined distance one from the other, wherein pairs of adjacent panels define flow channels of said flue gas which are closed laterally by shoulders and which have at the opposite ends respectively an inlet aperture in communication with said inlet manifold and an outlet aperture in communication with said outlet manifold, and circulation ducts of a cooling fluid associated with said panels.

In a preferred embodiment the pairs of panels, i.e. the flow channels of the flue gas, alternate with hollow spaces defined between the panels themselves.

In a further preferred embodiment two lateral shoulders are provided that close the opposite sides of all flow channels of the flue gas. Alternatively, each channel is laterally closed by a respective pair of shoulders. In any case, the shoulders, be they such as to simultaneously close all of the channels or each channel individually, are of the removable type, so as to allow easy access into the channels themselves to carry out cleaning and maintenance interventions.

In a preferred embodiment first simultaneous or selective closing means of the inlet apertures of the flow channels of the flue gas are provided and possibly also second simultaneous or selective closing means of the outlet apertures of the channels themselves.

In a further preferred embodiment each flow channel of the flue gas is laterally closed by respective removable shoulders and first and second selective closing means of the inlet and outlet apertures of the channels themselves are provided. Such a configuration permits to exclude a channel from the flow of the flue gas both to be able to intervene on it with maintenance and cleaning operations, and to tackle a reduction of the volumes of flue gas to be treated, whilst still keeping the others operative.

In a further preferred embodiment two modules in series are provided, with the respective channels aligned on the vertical.

The transversal section of the flow channels of the flue gas can decrease starting from their inlet aperture towards their outlet aperture, this is in order to compensate for the reduction in volume undergone by the flue gas as it progressively cools and to maintain a high flow speed.

Also forming the object of the present invention is an apparatus for the treatment of flue gas of ironwork plants, comprising a group for capturing the flue gas exiting from an electric arc furnace or from a converter, a pre-treating group of the captured flue gas, a heat exchanger as defined above and the inlet manifold of which is connected to the outlet of said pre-treating group and the outlet manifold of which is connected to an intake group of the flue gas, a post-treatment group of the flue gas exiting from said exchanger, a cooling fluid circuit that operates in said exchanger, wherein along said circuit a cooling group of the cooling fluid exiting from said exchanger is placed, with a recovery of the heat subtracted to said cooling fluid for the production of energy or of a warm service fluid.

Also forming the object of the present invention is a method for treating flue gas of ironwork plants, comprising the steps consisting of:

capturing the flue gas exiting from an electric arc furnace or from a converter at a temperature comprised between 500° C. and 1800° C.;

pre-treating the captured flue gas in a pre-treating group so as to obtain flue gas exiting from this latter at a temperature near to 800-900° C.;

letting the pre-treated flue gas pass through a heat exchanger by reducing their temperature to a value near to 200° C. with an average quenching speed greater than or equal to 300° C./sec, preferably 350° C./sec and even more preferably 400° C./sec, transferring the heat subtracted from said flue gas to a cooling fluid;

recovering the heat transferred to said cooling fluid for the production of energy or of a warm service fluid.

The cooling step of the flue gas takes place in a heat exchanger object of the present invention, which is passed through by the flue gas with an average flow speed greater than or equal to 15 m/s and permits to rapidly and drastically reduce the temperature of the flue gas roughly from 800-900° C. to 200° C. controlling the synthesis of dioxins and furans.

The cooling fluid is diathermic oil and the heat subtracted by it from the flue gas is recovered to produce energy, in particular electrical energy, or a warm service fluid, such as steam or hot water, or used itself as a vector fluid.

The characteristics and advantages of the present invention will become clearer from the following description, exemplifying and not limiting, referring to the attached schematic drawings, wherein:

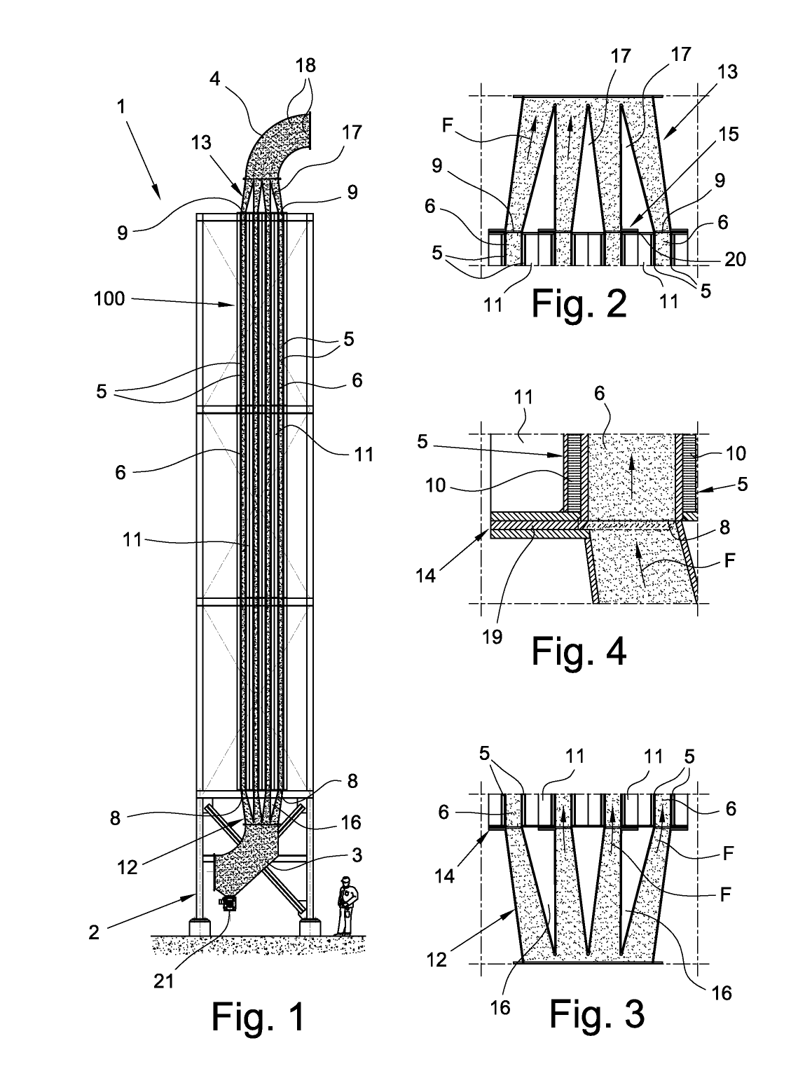

FIG. 1 is a schematic top side section of a heat exchanger according to the present invention;

FIGS. 2 and 3 schematically and with an enlarged scale, show the end details of the exchanger of FIG. 1;

FIG. 4 schematically and with an enlarged scale, shows a detail of FIG. 3;

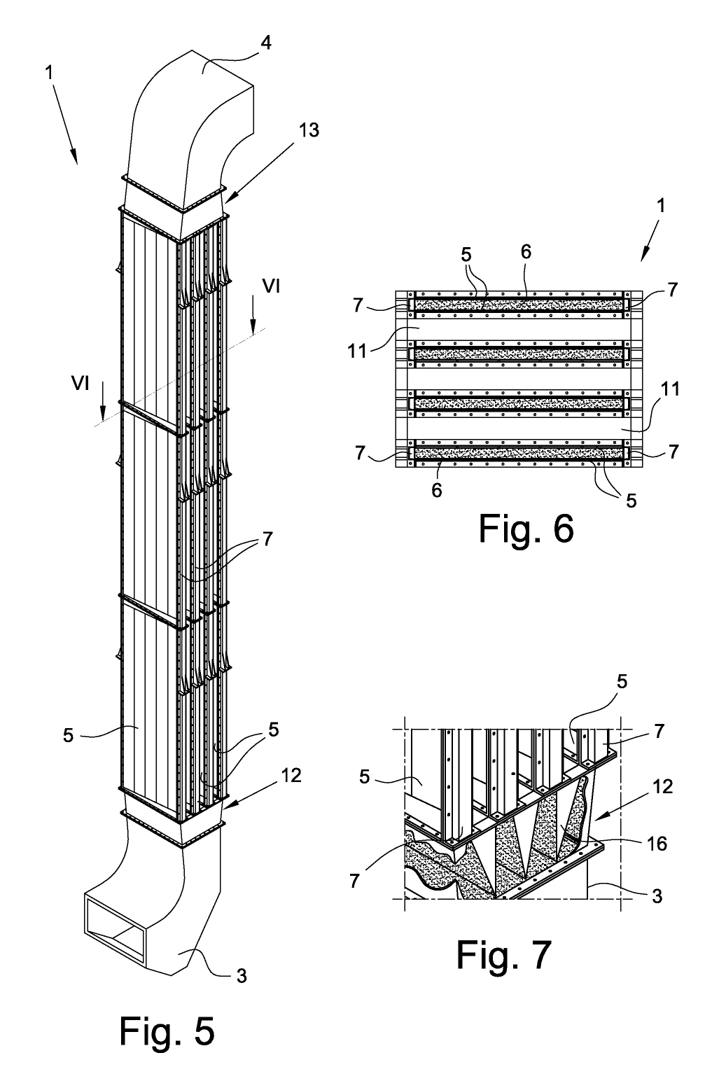

FIG. 5 is a schematic axonometric view of the exchanger of FIG. 1 without the support structure;

FIG. 6 is a schematic section according to the plane VI-VI of FIG. 5;

FIG. 7 schematically shows a partially sectioned view of an end detail of FIG. 5;

FIG. 8 schematically shows an exploded view of a portion of a flow channel of flue gas of the exchanger according to the present invention;

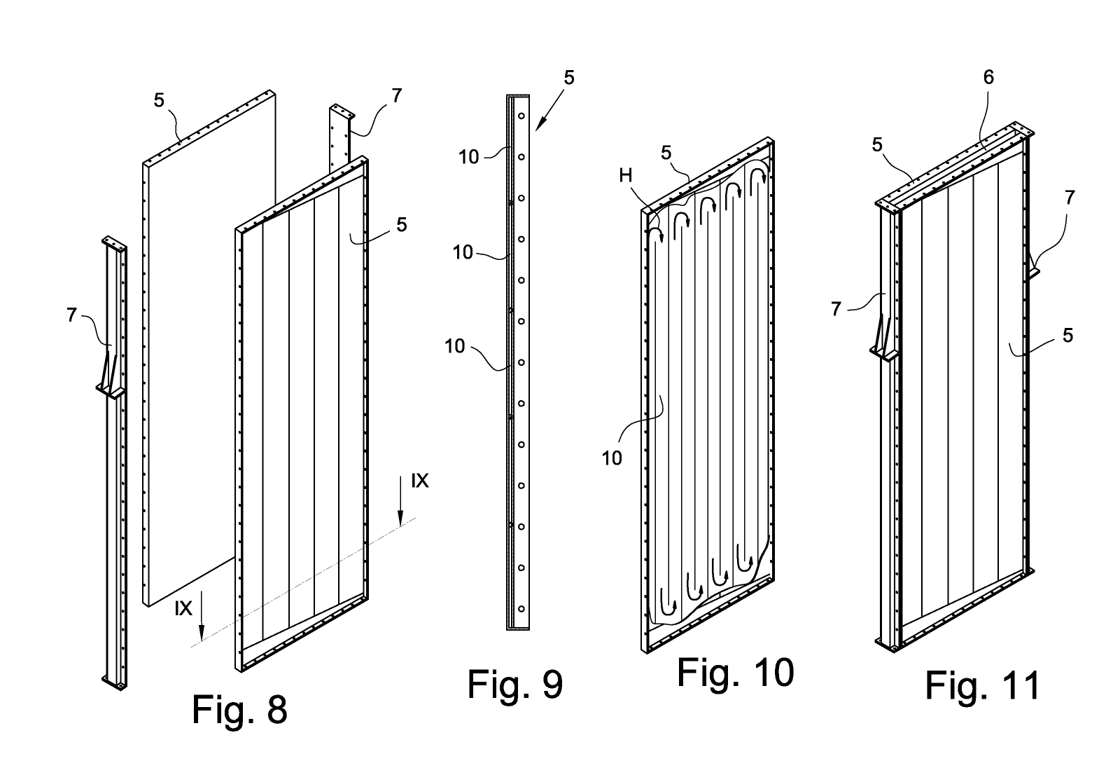

FIG. 9 is a schematic section according to the plane IX-IX of a panel of the exchanger according to the present invention;

FIG. 10 schematically shows the ducts inside the panel of FIG. 9;

FIG. 11 schematically shows an overall view of the channel portion of FIG. 8;

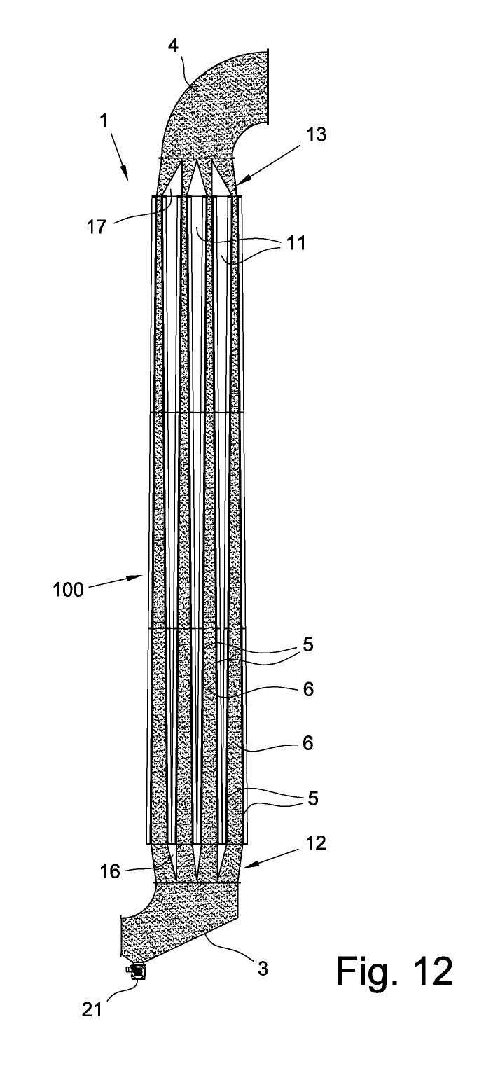

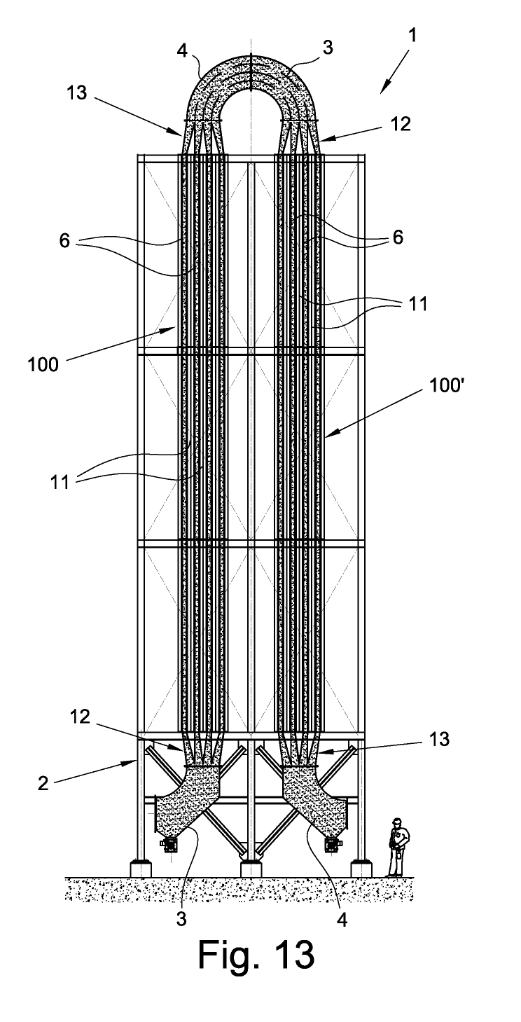

FIGS. 12 and 13 schematically show two different embodiments of the heat exchanger object of the present invention;

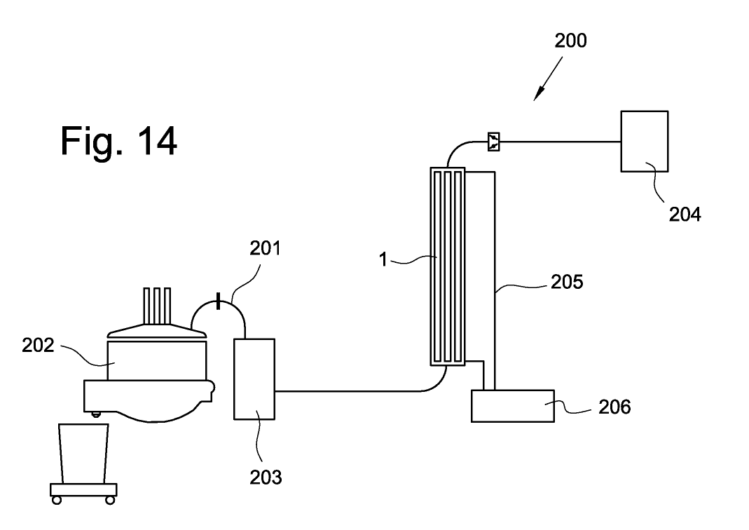

FIG. 14 shows the diagram of an apparatus for the treatment of flue gas of ironwork plants according to the present invention.

With reference to the figures, a heat exchanger for the rapid cooling of flue gas of ironwork plants is shown, wholly indicated with 1.

The heat exchanger 1 comprises a support structure 2 of at least one module 100 which in turn comprises an inlet manifold 3 of the flue gas and an outlet manifold of the flue gas which are mutually opposed and aligned.

Between the inlet manifold 3 and the outlet manifold 4 a plurality of panels 5 extend, which are mutually superimposed at a defined distance one from the other.

Pairs of adjacent panels 5 define flow channels 6 of the flue gas, channels 6 which are closed laterally by shoulders 7 and have at opposite ends respectively an inlet aperture 8 in communication with the inlet manifold 3 and an outlet aperture 9 in communication with the outlet manifold 4.

The panels 5 have circulations ducts 10 of a cooling fluid, advantageously diathermic oil, associated with them.

The pairs of panels 5 alternate with hollow spaces 11 defined between the panels themselves. Between the inlet manifold 3 and the inlet apertures 8 of the channels 6 distribution means 12 of the flue gas entering the channels themselves are interposed.

Similarly, between the outlet apertures 9 of the channels 6 and the outlet manifold 4 conveyor means 13 of the cooled flue gas exiting towards the outlet manifold itself are interposed.

First simultaneous or selective closing means 14 of the inlet apertures 8 of the channels 6 and second simultaneous or selective closing means 15 of the outlet apertures 9 of the channels 6 are moreover provided.

With particular reference to FIGS. 8-10, each channel 6 is delimited by two panels 5, which can be realized from modules assembled together. In FIGS. 8-11 just one of such modules is shown, which, therefore, forms a portion of the panels 5, whereas in FIGS. 1, 5, 12 and 13 panels 5 consisting of many assembled modules are shown.

Each panel 5 is realized in thermally conductive material. Inside each panel 5 the circulation ducts 10 of the cooling fluid are present. The flow of cooling fluid can be in counter-current or in equi-current with respect to the flow of flue gas. The man skilled in the art well understands that the number, arrangement, dimensions and shape of realization of the ducts 10 can vary according to different design conditions and that the flow indicated in FIG. 10 is purely indicative and not limiting.

The face of the panels 5 destined to define the inner surface of the channels 6 is flat and smooth, i.e. without roughness, so as to reduce the risk of abrasion thereof by the dusts present in the flue gas.

In a preferred embodiment, each channel 6 defined between a pair of panels 5 is closed laterally by a respective pair of shoulders 7 at least one of which is of the removable type; preferably each channel 6 defined between a pair of panels 5 is closed laterally by a respective pair of shoulders 7 both of the removable type.

In an alternative embodiment, not depicted, a single pair of shoulders is provided, also of the removable type, which close the opposite sides of all channels 6.

In any case, the possibility of removing the lateral closing shoulders 7 allows easy access to the channels 6 so as to be able to carry out cleaning and maintenance interventions.

In the case in which each channel 6 is laterally closed by a respective pair of shoulders 7 it is possible to intervene on a single channel 6 at a time.

The distribution means 12 comprise a plurality of wedge-shaped bodies 16 each of which is arranged so that its base extends between two adjacent panels 5 of two successive channels 6 and its inclined faces extend from the panels 5 themselves as represented in FIGS. 1 and 3.

The wedge-shaped bodies 16 divide the flue gas entering the exchanger 1 among the various channels 6.

Similarly, the conveyor means 13 comprise a plurality of wedge-shaped bodies 17 each of which is arranged so that its base extends between two adjacent panels 5 of two successive channels 6 and its inclined faces extend from the panels 5 themselves as represented in FIGS. 1 and 2.

The wedge-shaped bodies 17 convey the cooled flue gas exiting towards the outlet manifold 4 reducing the possibility of vortexes forming that could increase the abrasive effect of the dusts present in the flue gas.

Inside the outlet manifold 4 flow deviators 18 are also present.

The first closing means 14 of the inlet apertures 8 of the channels 6 can consist of a single suitably shaped mobile plate or of the wedge-shaped bodies 16 themselves that, in such a case, will be mounted in a mobile manner between a configuration wherein their base extends between the adjacent panels 5 of two successive channels 6 and a configuration wherein their base overlaps the inlet aperture 8 of one of such channels 6.

In the embodiment represented in FIGS. 1-3, the first closing means 14 comprise a plurality of sash-type doors 19 each of which is suitable for closing the inlet aperture 8 of a channel 6.

Similarly, the second closing means 15 of the outlet apertures 9 of the channels 6 can consist of a single suitably shaped mobile plate or of the wedge-shaped bodies 17 themselves that, in such a case, will be mounted in a mobile manner between a configuration wherein their base extends between the adjacent panels 5 of two successive channels 6 and a configuration wherein their base sits overlaps the outlet aperture 9 of one of such channels 6.

In the embodiment represented in FIGS. 1-3, the second closing means 15 comprise a plurality of sash-type doors 20 each of which is suitable for closing the outlet aperture 9 of a channel 6.

The man skilled in the art well understands that in the case in which the first and second closing means 14 and 15 allow the inlet and outlet apertures 8, 9 of one or more of the channels 6 to be selectively respectively closed, it is also possible to isolate a single channel 6, whilst still keeping the others active, so as to be able to intervene on it for maintenance and cleaning reasons or to deal with a reduction in volumes of flue gas to be treated.

The provision of first and second closing means 14 and 15 that allows the inlet and outlet apertures 8, 9 of one or more of the channels 6 to be respectively selectively closed, in combination with the provision for each channel 6 of respective lateral shoulders 7, at least one of which and preferably both are of the removable type, permits to isolate and exclude from the operation of the exchanger 1 one or more channels 6 in a selective manner, keeping the remaining ones active, so as to be able to carry out maintenance and cleaning interventions on the channels 6 thus excluded without having to shut off the operation of the entire exchanger 1.

In order to compensate for the reduction in volume undergone by the flue gas due to the cooling and still ensure a high flow speed inside the exchanger 1, a speed which, on average, has a value greater than or equal to 15 m/s, the transversal section of the channels 6 decreases starting from their inlet apertures 8 towards their outlet apertures 9.

In an embodiment, the panels 5 are parallel to one another and the reduction in section of the channels 6 is obtained by progressively reducing the width of the panels 5. For the man skilled in the art it is obvious that the reduction in width of the panels 5 can occur in a graduated discreet manner or continuously.

In an alternative embodiment, the panels 5 are arranged mutually inclined converging towards the outlet aperture 9 of each channel 6, as represented in FIG. 12. Also in this case the reduction in distance between the two panels 5 that delimit a channel 6 can occur continuously or in a graduated discreet manner.

In both cases, the reduction of the transversal section of the channels 6 between their inlet aperture 8 and their outlet aperture 9 is of the order of 50%, being of such an order of magnitude the expected reduction in volume of the flue gas during their cooling.

In the embodiment represented in FIGS. 1-7, the exchanger 1 comprises a single module 100 the inlet and outlet manifolds 3, 4 of which are aligned on the vertical with the inlet manifold 3 at the lower end, where collecting and evacuating means of the dusts that separate from the flue gas are provided, said means consisting for example of a hopper 21.

In such an embodiment, the panels 5 are parallel to one another and have a constant width.

FIG. 12 shows an alternative embodiment of the exchanger 1 wherein the channels 6 have a decreasing transversal section towards their outlet aperture 9.

In FIG. 13 a heat exchanger is represented, which comprises two modules 100, 100′ that are arranged side-by-side with the respective inlet and outlet manifolds 3, 4 aligned on the vertical and that are connected together in series with the outlet manifold 4 of the first module 100 joined to the inlet manifold 3 of the second module 100′. The inlet manifold 3 of the first module 100 and the outlet manifold 4 of the second module 100′ are arranged at the lower end of the exchanger 1 and each of them is provided with a respective hopper 21.

In order to take into account the reduction in volume of the flue gas as it cools down, the width of the panels 5 of the second module 100′ will be less than the width of the panels 5 of the first module 100, alternatively, the number of channels 6 of the second module 100′ could be less than the number of channels 6 of the first module 100.

Such a configuration ensures that, even in the case of accidental reduction in flow speed of the flue gas, the dusts or possible solid aggregates present in them separate by gravity and are collected on the bottom of the second module 100′.

For the same overall length of the channels 6, such a configuration permits a reduction in the height of the two modules 100, 100′ allowing the exchanger 1 to be installed even in locations wherein there are space limitations in the vertical direction.

In the attached figures the flow of flue gas has been schematised, in an exemplifying and not limiting manner, by the arrows F, whereas that of the cooling fluid has been schematised by the arrows H.

The man skilled in the art well understands that the number of panels 5 and, therefore, of channels 6 can vary according to the requirements of the case, just as the number of modules 100 can vary, connected in series or in parallel. For example, each module 100 can be arranged horizontally, instead of vertically as represented in the attached figures.

FIG. 14 shows a treatment apparatus 200 of flue gas of ironwork plants incorporating the exchanger 1 according to the present invention.

The apparatus 200 comprises a group 201 for capturing the flue gas exiting from an electric arc furnace 202 or from a converter, a pre-treating group 203 of the captured flue gas, a heat exchanger 1 the inlet manifold of which is connected to the outlet of the pre-treating group 203 and the outlet manifold of which is connected to a group for suctioning the flue gas, not schematised, and a post-treatment group 204 of the flue gas exiting from the exchanger 1.

A circuit 205 of the cooling fluid is also provided, which operates in the exchanger 1, wherein along such a circuit 205 a cooling group 206 of the cooling fluid exiting from the exchanger 1 is placed with recovery of the heat subtracted to the cooling fluid for the production of electrical energy or of a warm service fluid.

The pre-treating group 203 comprises an afterburner of the captured flue gas and/or a pre-heating tunnel of the charge for the electric arc furnace 202.

The post-treatment group 204 for example comprises a dust remover or a filter.

The flue gas exiting from the electric arc furnace 202 is captured and conveyed into the pre-treating group 203. When exiting from the electric arc furnace 202 the flue gas has a temperature comprised between 500° C. and 1800° C.

In the pre-treating group 203, which for example consists of a pre-heating tunnel of the charge for the electric arc furnace, the flue gas gives a fraction of its heat so as to reach an output temperature near to 800-900° C.

The flue gas at 800-900° C. enters the exchanger 1 and, thanks to the suction group, passes through it at high speed, of the order of at least 15 m/s.

Inside the exchanger 1 the flue gas undergoes a reduction in temperature to a value close to 200° C. with average quenching speed greater than or equal to 300° C./sec, preferably 350° C./sec, even more preferably 400° C./sec, transferring heat to the cooling fluid. Possible particulate that separates from the flue gas collects in the hopper 21 of the exchanger 1.

Such rapid and drastic cooling allows the synthesis of dioxins and furans to be controlled or even better prevented.

The heat transferred to the cooling fluid is recovered in the cooling group 206 for the production of energy or of a warm service fluid.

The cooled flue gas exiting from the exchanger 1 is conveyed in a post-treatment group 204 like for example a filtering device.

The heat exchanger object of the present invention has the advantage of permitting a rapid and drastic cooling of the flue gas of ironwork plants with a particularly simple and modular structure that can be easily adapted to existing plants.

The heat exchanger object of the present invention, thanks to the particular structure of the single channels that form it, permits to simply and easily carry out maintenance and cleaning interventions without having to necessarily shut off the plant, thus ensuring continuity of operation thereof.

The heat exchanger object of the present invention, thanks to the possibility of selectively closing the channels of which it consists, permits to ensure the desired reduction in temperature even in the case of a variation of the volumes of flue gas to be treated.

Moreover, the structure and configuration of the individual flow channels of the flue gas, which, in the basic form are delimited by flat panels arranged according to the faces of a parallelepiped, favours the flow itself, reducing the risks of abrasion of the panels themselves.

An apparatus for the treatment of flue gas of ironwork plants according to the present invention has the advantage of recovering the heat subtracted from the flue gas to produce energy or a warm service fluid.

The heat exchanger and the apparatus for the treatment of flue gas of ironwork plants thus conceived can undergo numerous modifications and variants, all of which are covered by the invention; moreover, all of the details can be replaced by technically equivalent elements. In practice, the materials used, as well as the sizes, can be whatever according to the technical requirements.

1-26. (canceled)

27. A heat exchanger for rapid cooling of flue gas of ironwork plants, comprising:
a support structure of at least one module which in turn includes an inlet manifold of flue gas and an outlet manifold of the flue gas that are mutually opposed and aligned;
a plurality of panels extending between the inlet manifold and the outlet manifold and that are mutually superimposed at a defined distance one from the other, wherein pairs of adjacent panels define flow channels of the flue gas, which are closed laterally by shoulders and which includes at opposite ends respectively an inlet aperture in communication with the inlet manifold and an outlet aperture in communication with the outlet manifold;
circulation ducts of a cooling fluid associated with the panels;
first selective closing means of the inlet apertures of one or more of the channels and second selective closing means of the outlet apertures of one or more of the channels;
wherein each of the channels is closed laterally by a respective pair of shoulders of which at least one is of removable type.

28. A heat exchanger according to claim 27, wherein the pairs of panels alternate with hollow spaces defined between the panels.

29. A heat exchanger according to claim 27, wherein each of the shoulders is of removable type.

30. A heat exchanger according to claim 27, further comprising, between the inlet manifold and the inlet apertures of the channels, distribution means of the flue gas entering the channels.

31. A heat exchanger according to claim 27, further comprising, between the outlet apertures of the channels and the outlet manifold, conveyor means of the flue gas exiting towards the outlet manifold.

32. A heat exchanger according to claim 30, wherein the distribution means comprises a plurality of wedge-shaped bodies, a base of which extends between adjacent panels of two subsequent channels, inclined faces of which protrude from the panels.

33. A heat exchanger according to claim 32, wherein the first closing means or the second closing means comprise the wedge-shaped bodies that are movably mounted between a configuration wherein their base extends between adjacent panels of two subsequent channels and a configuration wherein their base overlaps the inlet aperture or the outlet aperture of one of subsequent channels.

34. A heat exchanger according to claim 27, wherein the first closing means and/or the second closing means comprises, for each of the channels, respective sash doors.

35. A heat exchanger according to claim 27, wherein a transversal section of the channels decreases from the inlet aperture towards the outlet aperture.

36. A heat exchanger according to claim 35, wherein the panels have a decreasing width starting from their end near to the inlet aperture towards their end near to the outlet aperture.

37. A heat exchanger according to claim 35, wherein the panels of each pair are inclined and converging towards the outlet aperture.

38. A heat exchanger according to claim 27, wherein the panels are mutually parallel.

39. A heat exchanger according to claim 27, wherein the inlet manifold and the outlet manifold are aligned on the vertical and further comprising at a lower end of the heat exchanger, collecting and evacuating means of the ducts that are separate from the flue gas.

40. A heat exchanger according to claim 27, further comprising at least two of the modules mutually connected in series with the outlet manifold of the first module joined to the inlet manifold of the second module.

41. A heat exchanger according to claim 40, wherein the modules are disposed side by side with their respective inlet and outlet manifolds aligned on the vertical.

42. A heat exchanger according to claim 27, wherein each of the panels has a modular structure.

43. An apparatus for treatment of flue gas of ironwork plants, comprising:
a group for capturing flue gas exiting from an electric arc furnace or from a converter;
a group pre-treating the captured flue gas;
a heat exchanger according to claim 27, an inlet manifold of which is connected to an outlet of the pre-treating group and an outlet manifold of which is connected to a group for suctioning flue gas;
a post-treating group of the flue gas exiting from the exchanger;
a circuit of cooling fluid working in the exchanger, wherein along the circuit a cooling group of the cooling fluid exiting from the exchanger is placed, with a recovery of the heat subtracted to the cooling fluid.

44. An apparatus according to claim 43, wherein the pre-treating group includes a post-combuster of the captured flue gas and/or a tunnel for preheating the charge for an electric arc furnace.

45. An apparatus according to claim 43, wherein the cooling group recovers the heat for producing energy or a warm service fluid.

46. An apparatus according to claim 43, wherein the post-treatment group includes a dust remover or a filter.

47. A method for treating flue gas of ironwork plants, comprising:
capturing flue gas exiting from an electric arc furnace or from a converter at a temperature between 500° C. and 1800° C.;
pre-treating the captured flue gas in a pre-treating group to obtain flue gas exiting from the pre-treating group at a temperature near to 800-900° C.;
letting the pre-treated flue gas pass through a heat exchanger according to claim 27 by reducing their temperature at a value near to 200° C. with an average quenching speed greater that or equal to 300° C./sec, or equal to 350° C./sec, or equal to 400° C./sec, by transferring heat subtracted to the flue gas to a cooling fluid;
recovering the heat transferred to the cooling fluid for production of energy or of a warm service fluid.

48. A method according to claim 47, wherein in the passing-through an average flow speed of the flue gas is greater than or equal to 15 m/s, or is between 35 m/s and 50 m/s.

49. A method according to claim 47, further comprising a post-treatment of the flue gas exiting from the heat exchanger.

50. A method according to claim 47, wherein the pre-treatment includes letting the flue gas exiting from the electric arc furnace pass in a pre-heating tunnel of the charge of the electric arc furnace, ones counter-current with the other, wherein inside the tunnel the flue gas transfers a fraction of its heat to the scraps.

51. A method according to claim 47, wherein the pre-treating includes post-oxidation of the flue gas exiting from the electric arc furnace.

52. A method according to claim 47, wherein the cooling fluid is diathermic oil.
